(19) United States
(12) Patent Application Publication
(10) Pub. No.: US 2019/0213612 A1
(43) Pub. Date: Jul. 11, 2019

(54) MAP BASED VISUALIZATION OF USER INTERACTION DATA

(71) Applicant: Clickagy, LLC, Roswell, GA (US)

(72) Inventors: Harry Russell Maugans, III, Roswell, GA (US); Cody Alan Carrell, Roswell, GA (US)

(21) Appl. No.: 16/354,101

(22) Filed: Mar. 14, 2019

Related U.S. Application Data
(63) Continuation-in-part of application No. 15/177,168, filed on Jun. 8, 2016.
Application No. 15/177,168 is a continuation-in-part of application No. 15/177,178, filed on Jun. 8, 2016.
Application No. 15/177,178 is a continuation-in-part of application No. 15/177,193, filed on Jun. 8, 2016.
(60) Provisional application No. 62/173,071, filed on Jun. 9, 2015.
(60) Provisional application No. 62/173,071, filed on Jun. 9, 2015.
(60) Provisional application No. 62/173,071, filed on Jun. 9, 2015.
(60) Provisional application No. 62/642,640, filed on Mar. 14, 2018.

(51) Int. Cl. G06Q 30/02; G06F 16/29; G06N 20/00; G06Q 20/20

(52) U.S. Cl. CPC G06Q 30/0203; G06Q 20/20; G06N 20/00; G06F 16/29

(57) ABSTRACT

Disclosed is a method and system for providing map-based visualization of user interaction data. The platform may be configured to monitor online activity of consumers across a plurality of webpages. As a result, the plurality of webpages visited by the consumer may be determined by the online platform. Further, the online platform may be configured to access and parse each webpage in the plurality of webpages in order to extract key elements. Furthermore, the platform may be configured to aggregate key elements extracted from each of the plurality of webpages and perform an analysis. Based on the analysis, the consumer may be determined to be in-market with regard to a product and/or a service. Further, based on the analysis, providing a location-based user interface for viewing online behavior data associated with individuals located in different places may also be determined.

### RELATED APPLICATIONS

Under provisions of 35 U.S.C. § 119(e), the Applicant claims the benefit of U.S. provisional application no. 62/642,640, filed Mar. 14, 2018, which is incorporated herein by reference.

The present application is also a continuation-in-part filing of the following U.S. utility patent applications:

U.S. patent application Ser. No. 15/177,168, entitled “METHOD, SYSTEM AND COMPUTER READABLE MEDIUM FOR CREATING A PROFILE OF A USER BASED ON USER BEHAVIOR,” having Attorney Docket No. 279E.P001US01, and claiming priority to U.S. Provisional Patent Application No. 62/173,071 filed on Jun. 9, 2015. The disclosure of the aforementioned application is incorporated by reference herein as “the '168 disclosure.”

U.S. patent application Ser. No. 15/177,178, entitled “METHOD AND SYSTEM FOR PROVIDING BUSINESS INTELLIGENCE BASED ON USER BEHAVIOR,” having Attorney Docket No. 279E.P001US02, and claiming priority to U.S. Provisional Patent Application No. 62/173,071 filed on Jun. 9, 2015. The disclosure of the aforementioned application is incorporated by reference herein as “the '178 disclosure.”

U.S. patent application Ser. No. 15/177,193, entitled “METHOD AND SYSTEM FOR CREATING AN AUDIENCE LIST BASED ON USER BEHAVIOR DATA,” having Attorney Docket No. 279E.P001US03, and claiming priority to U.S. Provisional Patent Application No. 62/173,071 filed on Jun. 9, 2015. The disclosure of the aforementioned application is incorporated by reference herein as “the '193 disclosure.”

U.S. patent application Ser. No. 15/177,204, entitled “METHOD AND SYSTEM FOR INFLUENCING AUCTION BASED ADVERTISING OPPORTUNITIES BASED ON USER CHARACTERISTICS,” having Attorney Docket No. E279P.001US04, and claiming priority to U.S. Provisional Patent Application No. 62/173,071 filed on Jun. 9, 2015. The disclosure of the aforementioned application is incorporated by reference herein as “the '204 disclosure.”

U.S. patent application Ser. No. 15/689,845, entitled “AN ONLINE PLATFORM FOR PREDICTING CONSUMER INTEREST LEVEL,” having Attorney Docket No. 279E.P002US01, and claiming priority as a CIP of U.S. patent applications Ser. No. 15/177,168; 15/177,178; 15/177,193 filed on Jun. 8, 2016. The disclosure of the aforementioned application is incorporated by reference herein as “the '845 disclosure.”

The disclosures above-referenced applications are hereby incorporated into the present application by reference, in their entirety. It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to online behavioral analysis. More specifically, the present disclosure relates to monitoring and analyzing online behavior of consumers in order to determine if consumers are in-market for one or more products and/or services. The present disclosure further relates to graphical map-based visualizations of user interaction data.

### BACKGROUND

With advancements in technologies, consumers are exposed to an increasing amount of information on a daily basis. In particular, the advent of mobile technologies has enabled unprecedented accessibility to information irrespective of time or place. As a result, consumers increasingly face difficulty in receiving information relevant to them. In other words, information currently presented to consumers is largely irrelevant to the user's interests and/or intentions. Further, although existing systems perform targeted information dissemination to some extent by identifying consumers' interests, such techniques are limited. For instance, existing systems target content, such as infomercials to consumers based on key elements present on a webpage being viewed by the user. As a result, consumers may not be able to view information, such as advertisements regarding products and/or services that is relevant to their immediate needs or intentions.

On the other hand, content providers, such as webpage publishers also face challenges in accurately identifying locations and interests and/or intentions of consumers. Existing techniques largely rely on information regarding locations and interests explicitly provided by consumers. However, such interests may be large in number, while a user at any given time may be interested in a smaller subset of such interests. Further, user interests vary in time and accordingly to contexts and locations. As a result, information regarding interests may not be dynamic in nature to follow such variations.

Accordingly, there is a need for methods and systems for identifying user interests and/or intentions based on user behavior and location.

### BRIEF OVERVIEW

A map-based visualization of user interaction data may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Disclosed is providing a location-based user interface for viewing online behavior data associated with users located in different places. The platform may be configured to monitor online activity of consumers across a plurality of webpages. Accordingly, each webpage of the plurality of webpages may include a tracking cookie configured to identify a user accessing a respective webpage based on a unique ID of the user. Alternatively, each webpage of the plurality of webpages may include code configured to retrieve a tracking cookie from a user device of the user. The ID is associated with the plurality of visited webpages. As a result, the plurality of webpages visited by the user may be determined and aggregated by the online platform for each visitor.

Further, the online platform may be configured to access each webpage in the plurality of webpages and retrieve content, such as, but not limited to, textual content, from each webpage. The content retrieved from each webpage may be parsed in order to extract key elements. The platform may be configured to aggregate key elements extracted from each of the plurality of webpages and perform an analysis, such as, but not limited to, a machine learning or Artificial Intelligence (AI) based analysis on the aggregate key elements. Based on the analysis, the user may be determined to be in-market with regard to a product and/or a service, in addition to being categorized in a plurality of different categories.

Further, based on the analysis, a confidence value representing a degree to which the user fits a category, or is in-market with respect to the product and/or the service, may also be determined. Accordingly, based on determining the user as in-market, content, such as advertisements, associated with the product and/or the service may be presented to the user.

In some embodiments, the presentation of the confidence value may be integrated with an existing CRM platform associated with a platform user. In this way, the CRM platform may be used to trigger marketing campaigns to consumers with certain in-market scores/confidence levels.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates a block diagram of an operating environment consistent with the present disclosure.

FIG. 1B illustrates a block diagram of an operating environment consistent with the present disclosure.

FIG. 2 illustrates a flowchart of a method 200 of tracking a user across multiple webpages in order to determine in-market status of the user, in accordance with some embodiments.

FIG. 3 illustrates a block diagram of an operating environment consistent with the present disclosure.

FIG. 4 illustrates a block diagram of an operating environment consistent with the present disclosure.

FIG. 5 illustrates a block diagram of an operating environment consistent with the present disclosure.

FIG. 6 illustrates a block diagram of an operating environment consistent with the present disclosure.

FIG. 7 illustrates a block diagram of an operating environment consistent with the present disclosure.

FIG. 8 illustrates a block diagram of an operating environment consistent with the present disclosure.

FIG. 9 illustrates a block diagram of an operating environment consistent with the present disclosure.

FIG. 10 illustrates a block diagram of an operating environment consistent with the present disclosure.

FIG. 11 illustrates a block diagram of an operating environment consistent with the present disclosure.

FIG. 12 illustrates a flowchart of a method 1200 of determining in-market status of consumers, in accordance with some embodiments.

FIG. 13 illustrates a block diagram of a system 1300 for implementing the online platform for predicting consumer interest level, in accordance with some embodiment.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of in-market status with respect to products and/or services, embodiments of the present disclosure are not limited to use only in this context. For example, the platform may also be used to identify fine-grained interests and/or intentions of performing actions (e.g. attending an event, performing a physical activity, meeting a person, etc.). Furthermore, it should be understood that the location of any user may be an approximation based on a number of factors.

### I. Platform Overview

Consistent with embodiments of the present disclosure, an online platform for providing map-based visualizations of user interaction data (also referred to herein as the “platform”) may be provided. This overview is provided to introduce a selection of concepts in a simplified form that are further described below. This overview is not intended to identify key features or essential features of the claimed subject matter. Nor is this overview intended to be used to limit the claimed subject matter's scope. The online platform may be used by individuals or companies to identify aspects about the world of consumers. The aspects may include, by way of non-limiting example, who may be in-market for a product and/or a service with a calculated degree of confidence. Accordingly, targeted information, such as, but not limited to, advertisements may be presented to such consumers in order to aid the consumers to make informed buying decisions while also enhancing the likelihood of a user making a purchase of the product and/or service. Although embodiments of the present disclosure may be disclosed with reference to a “webpage publisher,” “advertiser,” “agency,” or a “content provider” as a platform user, any individual or entity may be a platform user.

The present disclosure provides methods of and systems for predicting a consumer as being a part of a particularly category or, for example, in-market, based on collection and scoring (either statistically or using machine learning) of pieces of data extracted from webpages visited by the consumer based on the computer device associated with the consumer, such as a. The present disclosure provides methods of and systems for providing a location-based user interface for viewing online behavior data associated with individuals located in different places.

Embodiments of a platform described herein may provide visualizations for the various aspects of the consumers. Possible user of the platform may be, for example, webpage publisher, advertiser, agency, or a content provider in order to determine, for example, which advertisement media to present, how to target the advertisements, and who to display the advertisements to. A webpage publisher may join a network of publishers (e.g. an ad-network) in order to collectively determine in-market status of consumers. The network may be associated with a plurality of webpages, each tracking-enabled. Tracking the consumers' online behavior may include identifying webpages visited by the consumers when those webpages are, for example, part of the network. In an instance, this may be accomplished by aggregating a large network of webpage publishers who have a common element on their webpage. The common element may be the use of a network recognized cookie, or identifier, for each visitor who accesses any one webpage of the network of webpages. In some instances, multiple such networks of webpages may associate, share or sell information amongst each other to build larger networks, thereby expanding the webpage base for online behavioral tracking.

Further, in some instances, each webpage of the network of webpages may include a component configured to execute on a respective webpage and affect an action on a user device of the user visiting the respective webpage. The component may include, for example, but not limited to, JavaScript code. Additionally, in some instances, the JavaScript code may be configured for provisioning advertisements on the respective webpage.

Accordingly, the present disclosure enables a webpage publisher to determine if a user visiting the webpage is ‘in-market’ for products and/or services that the webpage publisher provides. This is advantageous because if the user is ‘in-market’, the webpage publisher may execute an appropriate marketing or sales campaign to increase the likelihood that the user converts to a customer. (See the '193 disclosure.)

Still consistent with embodiments of the present disclosure, a platform user may not be a webpage publisher. Moreover, a platform user may specify certain criteria for determining an in-market user without being required to add any code to a webpage or join a network.

As an example, regardless of whether the platform use is a content provider, the platform user may specify that it seeks to locate consumers in the market for purchasing a computing device. The platform may then, in turn, commence an analysis of online behavioral data aggregated from multiple sources. One source may be, for example, but not limited to an ad network. Upon analysis, the platform may determine that a potential in-market consumer has visited three computing device review webpages. Accordingly, by tracking the consumer's online activity, the methods and systems disclosed herein may determine that the person looked at ‘tablet computing devices’ twice and focused on reviews considering “battery life”. Such information may be extracted from the multiple data sources by the platform using a plurality of techniques. Such as, for example, but not limited to, using a web crawler or from JavaScript code running on the webpages at the time the person visited them. Further, and as will be detailed below, the key elements extracted from the visited web pages may be analyzed in order to determine whether the consumer is in-market for or interested-in a product and/or a service. (See the '168 disclosure.)

In some embodiments, the methods and systems disclosed herein may also calculate a confidence score associated with the in-market status of the person with respect to the product and/or the service. For instance, the methods and systems disclosed herein may be able to determine that the person is 73% in-market for an Apple iPad, 59% in market for a Microsoft Surface, and 32% in market for some other tablet computing device. (See the '178 disclosure.)

Embodiments of the present disclosure may comprise methods, systems, and a computer readable medium comprising, but not limited to, at least one of the following:
A. Data Gathering Module ̂125; and
B. Data Analysis Module ̂135.
C. User Interface Module ̂145; and
D. Audience List Module ̂155.

Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each stage disclosed within each module can be considered independently without the context of the other stages within the same module or different modules. Each stage may contain language defined in other portions of this specifications. Each stage disclosed for one module may be mixed with the operational stages of another module. In the present disclosure, each stage can be claimed on its own and/or interchangeably with other stages of other modules.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

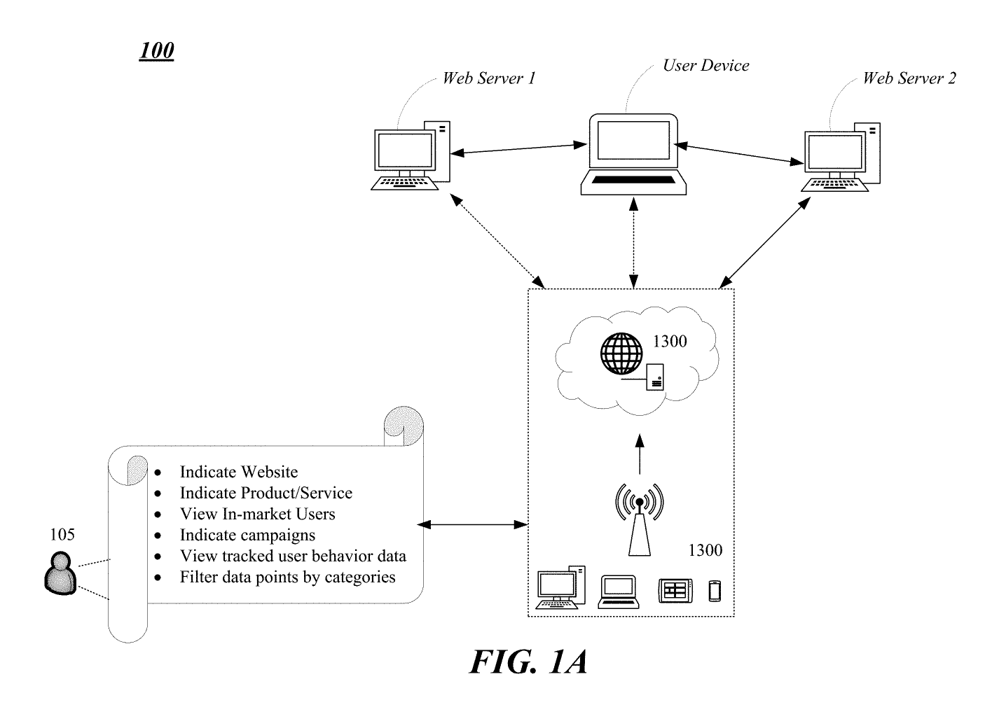

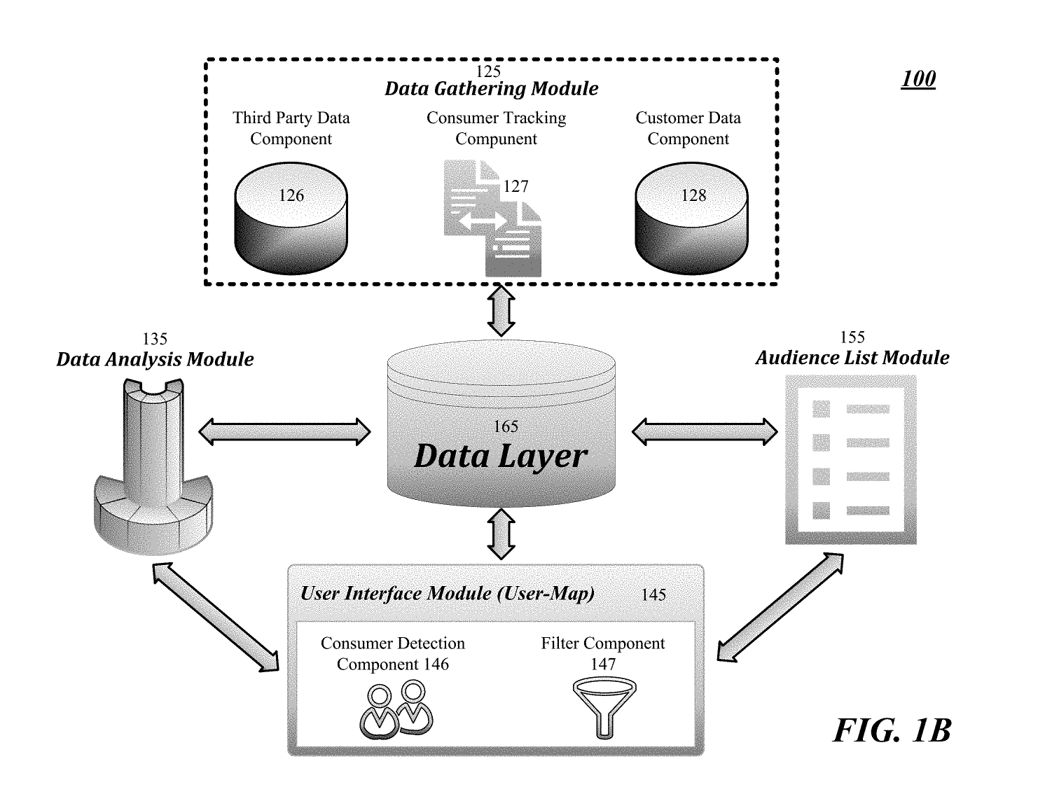

FIG. 1A illustrates one possible operating environment through which a platform consistent with embodiments of the present disclosure may be provided. By way of non-limiting example, an online platform 100 for predicting consumer interest level may be hosted on, for example, a cloud computing service 1300. In some embodiments, the platform 100 may be hosted on a server 1300. The centralized server may communicate with other network entities, such as, for example, a plurality of webpage servers (e.g. web server 1 and 2) hosting a plurality of webpages and a user device (e.g. laptop computer, smartphone, tablet computer, desktop computer etc.). Additionally, in some embodiments, the centralized server may also communicate with other entities such as databases, wearable devices, Point Of Sales (POS) terminals etc. In general, the centralized server may be configured to communicate with any entity capable of providing user behavior data that is representative of a buying intention of a consumer. A user 105, such as a manager of the online platform 100 and/or an administrator of a webpage may access platform 100 through a software application. The software application may be embodied as, for example, but not be limited to, a webpage, a web application, a desktop application, and a mobile application compatible with a computing device 1300. One possible embodiment of the software application may be provided by “In-Market-Audiences™” suite of products and services. Accordingly, the user 105 may provide, for example, indication of a list of webpages, indication of one or more products and/or services offered by a webpage of the list of webpages and indication of one or more campaigns to be targeted to the consumers with a detected interest level (hereinafter referred to “in-market consumers”). In response, the platform may identify in-market consumers based on online behavior and enable the user 105 to view the in-market consumers along with confidence values associated with products and/or services corresponding to which the in-market consumers are identified.

In order to determine the in-market consumers, the platform may be configured to track online activity of consumers. For instance, in some embodiments, the platform may be configured to use client-side or server-side cookies in order to track a user across a plurality of webpages. Accordingly, a cookie stored in the consumer device may be used to log each webpage of the plurality of webpages visited by the consumer device. Alternatively, the plurality of webpages may cooperate with each other to track the consumer device accessing each of the plurality of webpages. In other words, cookies stored at web servers corresponding to the plurality of webpages may log each access by the consumer device and may communicate such accesses amongst the plurality of web servers.

As an example, the consumer device may visit a webpage hosted on web server 1 and 2 within a short period of time, such as a day. Accordingly, each of web server 1 and 2 may create a log of the consumer device, represented by a unique ID, such as for example, a network address, an IMEI number, a combination of software, hardware and demographic information associated with a person operating the consumer device and so on. Such logs may be shared amongst the web servers by aggregating the logs at a single location, such as at the platform.

As a result of the tracking, for each unique ID representing a consumer, a list of webpages may be identified. The platform may then access each webpage in the list of webpages in order to retrieve key elements present in the content of each webpage. For example, the platform may perform scraping, OCR etc. in order to parse the content of each webpage. Further, the key elements may be aggregated, and an analysis may be performed on the aggregated key elements in order to identify in-market status of the consumer towards one or more products and/or services. Key elements may be analyzed based on a set of criteria in order to determine the corresponding consumer's in-market status. For example, the platform may be configured to assess various factors associated with the key elements, including, but not limited to, keywords, keyword density (e.g., frequency of occurrence on a webpage), themes associated with the webpage, time spent on a webpage, quantity of pages visited with related key elements, relevant pages, and parameters associated therewith. The analysis may be embodied using, at least in part, various machine learning methods and techniques. In turn, the analysis may also identify a confidence value associated with each product and/or service to which the in-market consumer status corresponds.

In one example, online behavioral data may be combined with purchasing data, retrieved from sales database, POS terminals etc. The combination may then be used to identify patterns of online browsing activity representing buying intentions. Such patterns may be identified by performing machine learning over the historical online browsing data (including purchasing data in some embodiments). Subsequently, the machine learning may be used to identify in-market status of the consumer based on currently received online behavior data. Additionally, users may view tracked online behavioral data. In some embodiments, the view may be filtered by various data points and categories. Further views may be correlated with a location, map, or graphical indication of the location associated with the tracked behavior. This location may be longitude, latitude, coordinates, Global Positioning System coordinates, an address, a neighborhood, a municipality, a mileage radius, or other type of location information.

Accordingly, as illustrated in FIG. 1B, embodiments of the present disclosure provide a software and hardware platform comprised of a distributed set of modules, including, but not limited to:
A. Data Gathering Module 125; and
B. Data Analysis Module 135.

In some embodiments, the present disclosure may provide an additional set of modules for further facilitating the software and hardware platform. The additional set of modules may comprise, but not be limited to:
C. User Interface Module 145; and
D. Audience List Module 135.

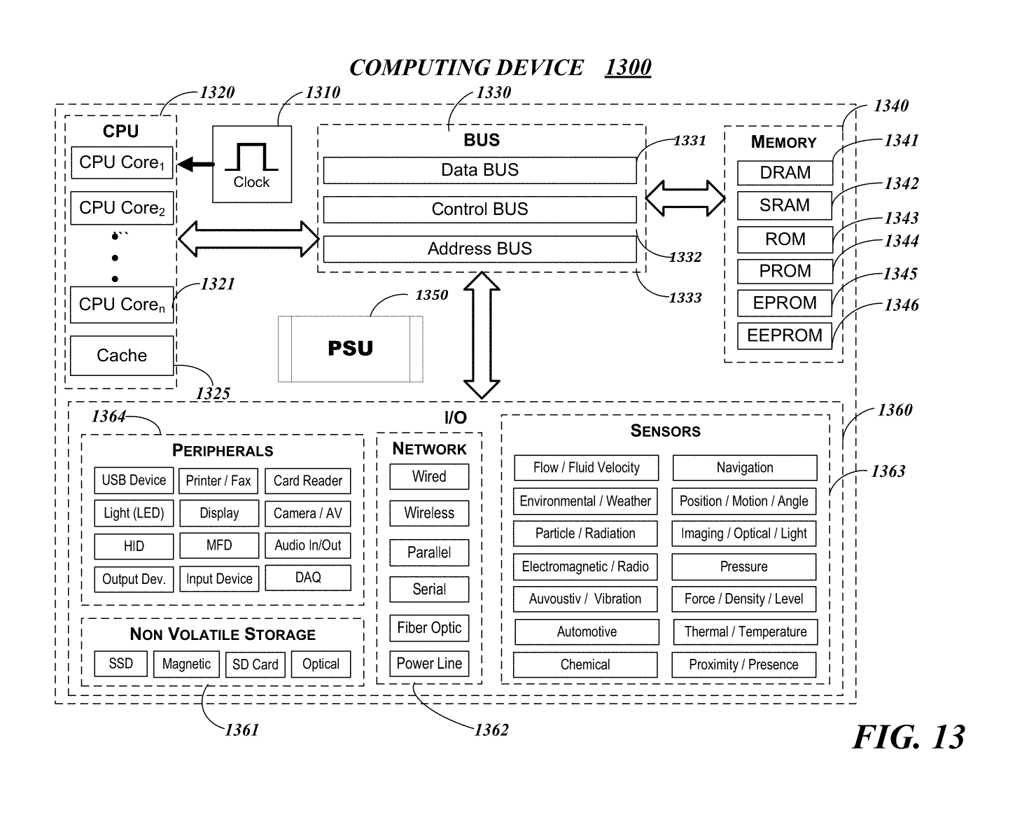

Each module may be in bi-directional communication with one another. The aforementioned modules and functions and operations associated therewith may be operated by a computing device 1300. In some embodiments, each module may be performed by separate, networked computing devices 1300; while in other embodiments, certain modules may be performed by the same computing device 1300. As will be detailed with reference to FIG. 13 below, the computing device 1300 through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

A. Data Gathering Module 125

Data Gathering Module 125 may be configured to gather data from a plurality of sources, including, but not limited to, third party data component 126. In some embodiments, consumer data may be gathered by a consumer tracking component 127 associated with, by way of example, a computing device 1300 corresponding consumer. Further still, consumer data may be provided directly from a platform user 105. For example, platform 100 may be configured to receive data from, or integrate with, a customer data component 128, such as a CRM associated with user 105. The received data may comprise a list of identifiers associated with a plurality of consumers. The platform may then be configured to track any device associated with the identifiers, or gather data associated with the identifiers. (See the 168 disclosure and the '178 disclosure.)

B. Data Analysis Module 135

The data may be stored in a data layer 175. Having the data, the platform may employ data analysis module 135 to analyze consumers behaviors and various characteristics and categorize the consumers in a plurality of categories. Furthermore, the platform may be configured to determine if the consumers are in-market for products and/or services. (See the '168 disclosure and the '845 disclosure.)

C. User Interface Module 145

Having determined the various categories and in-market status of the consumers, user interface module 145 may provide a visualization of the categorized and in-market data on the consumers. The visualization may further be geographic-specific, plotting consumer identifiers on a map. The consumers that are displayed may be determined by a plurality of filters and parameters specified by user 105 through a filter component 147, enabling a user to select parameters associated with the consumers they'd like to identify within the visualization.

D. Audience List Module 135

In some embodiments, a custom consumer detection component 146 may be configured to ascertain certain aspects regarding user 105 in order to provide a tailored list of potential consumers of interest to user 105. The consumers may have with an in-market status associated with user 105's offering, product, or service. For example, platform 100 may identify user 105 to be associated with automobiles. This may be done by way of, for example, a user identifier associated with a computing device associated with user 105. In turn, user interface module 145 may display those consumers interested in automobiles. Other methods and systems for ascertaining aspects of user 105 so as to determine which consumers may be of interest to user 105 are disclosed in the '845 disclosures. In some embodiments, platform 100 may employ customer data component 128 to make the same determination (e.g., only display consumers identified by user 105).

Still consistent with embodiments of the present disclosure, user 105 may be enabled to output a list of consumers using audience list module 155. An audience list may be further detailed in the '193 disclosure. The list may be based on the filtered set of displayed consumers. In some embodiments, the list may be output directly back to customer data component 168 (e.g., back to user 105's CRM). See the '204 disclosure. In some embodiments, the list may be employed in a bidding network to bid on the provision of an advertisement. See the '178 disclosure.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of a method of a plurality of methods that may be performed by at least one of the aforementioned modules. Various hardware components may be used at the various stages of operations disclosed with reference to each module.

For example, although methods 200 and 1200 have been described to be performed by platform 100, it should be understood that computing device 1300 may be used to perform the various stages of methods 200 and 1200. Furthermore, in some embodiments, different operations may be performed by different networked elements in operative communication with computing device 1300. For example, server 1300 may be employed in the performance of some or all of the stages in methods 200 and 1200. Moreover, server 1300 may be configured much like computing device 1300.

Furthermore, although methods 200 and 1200 have been described to be performed by platform 100, it should be understood that computing device 1300 may be used to perform the various stages of methods 200 and 1200. Furthermore, in some embodiments, different operations may be performed by different networked elements in operative communication with computing device 1300. For example, server 1300 may be employed in the performance of some or all of the stages in methods 200 and 1200. Moreover, server 1300 may be configured much like computing device 1300. Similarly, an apparatus may be employed in the performance of some or all of the stages in methods 200 and 1200. Apparatus may also be configured much like computing device 1300.

Still, although the stages of the following example methods are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Consistent with embodiments of the present disclosure, methods may be performed by at least one of the aforementioned modules. The methods may be embodied as, for example, but not limited to, computer instructions, which when executed, perform the methods.

The disclosed stages may be repeated for dynamically updated lists of webpages the consumer has been determined to have visited. Although the stages are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones illustrated and/or claimed below. Moreover, various stages may be added or removed from the without altering or deterring from the fundamental scope of the depicted methods and systems disclosed herein.

Ways to implement the stages of methods 200 and 1200 will be described in greater detail below.

Embodiments of the present disclosure provide a hardware and software platform operative as a distributed system of modules and computing elements.

According to some embodiments, the method may include a setup or ‘on-boarding’ phase, in which the targeted products and/or services for a platform user may be determined. In some embodiments, determining the products and/or services may be performed automatically by scraping/parsing a platform user's webpage for key elements. Alternatively, the platform user may provide inputs indicating the target products and/or services. Accordingly, in some instances, key elements associated with the webpage offering the products and/or services may be determined. These key elements may then serve as a base reference point when analyzing other webpages to determine in-market or interest status for a consumer. Having the base reference point set, the platform may be enabled to perform at least one of the following stages, in any order, at any time.

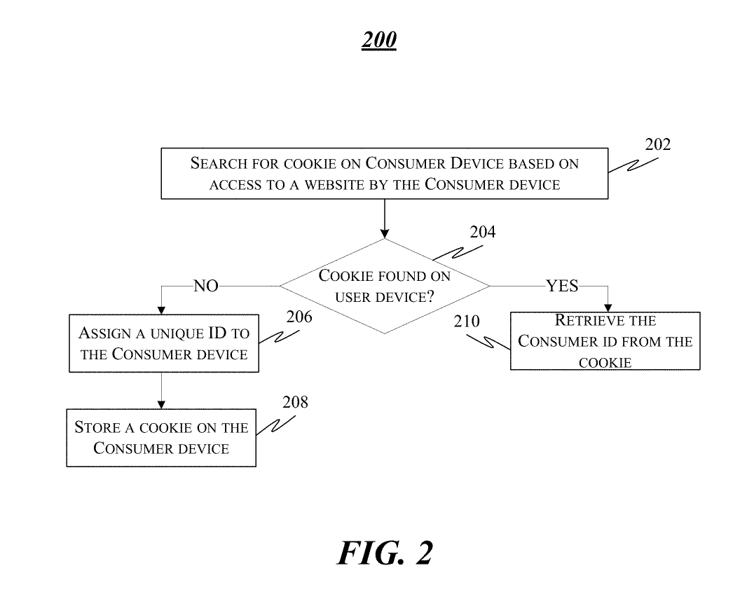

When a potential in-market prospect (hereinafter referred to as a “consumer”) visits a webpage, a code, such as Javascript code, embedded in the webpage may execute a method 200 as illustrated in FIG. 2. Accordingly, at stage 202, the code may search for a cookie on the consumer device associated with the consumer. Subsequently, at stage 204, a check is performed to determine whether the cookie was found on the consumer device. If no cookie is found, at stage 206, the code may assign a unique identifier (ID) to the consumer if no unique ID has been previously assigned. Subsequently, at stage 208, the code may store a cookie on the consumer device with the ID, among other information. On the other hand, if the code searches and finds a cookie on the consumer device, at stage 210, the unique ID stored in the cookie is retrieved. In this case, the cookie may have been previously stored when the consumer device accessed the webpage and/or any other webpage in the network of webpages in the past.

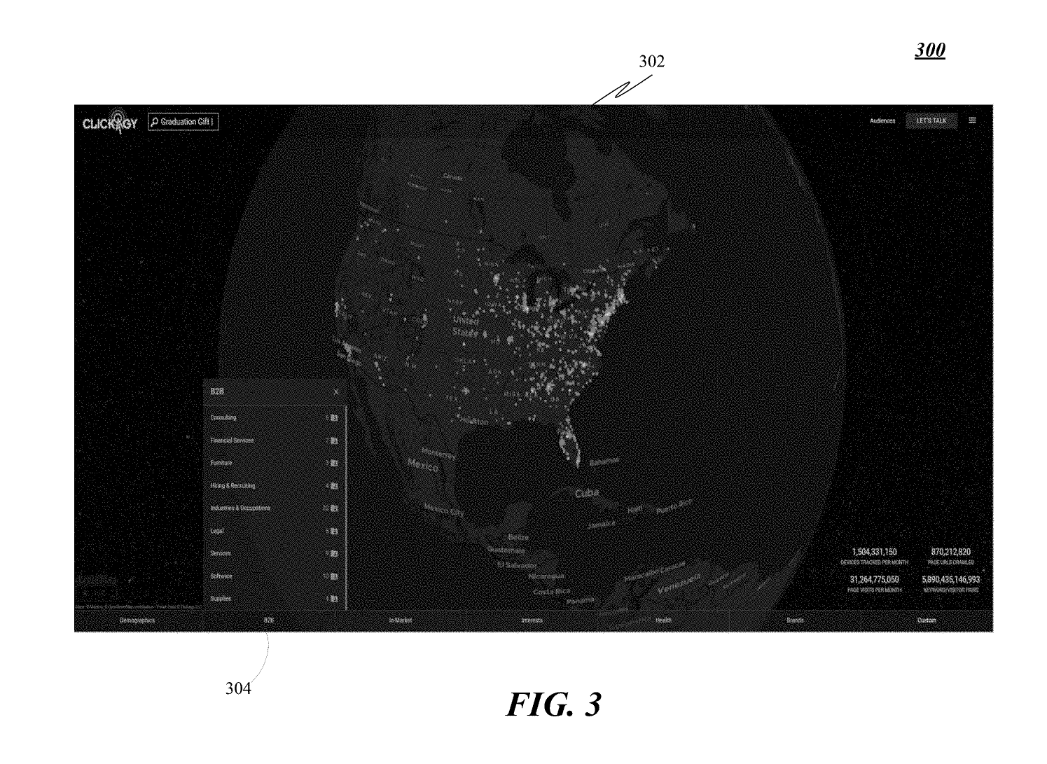

In another embodiment, when a user engages the platform 100, a code, such as Javascript code, embedded in the webpage may execute a method 1200 such that the online platform for providing map based visualizations of user interaction data presents an illustrative display screen representing the behavior data as illustrated in FIG. 3. Accordingly, data presentation screen 300, displays an embodiment of a B2B view. Additionally, callout 302, shows a graphical map display in accordance with the present disclosure. Furthermore, callout 304, indicates a representation of the B2B menu in accordance with the present disclosure.

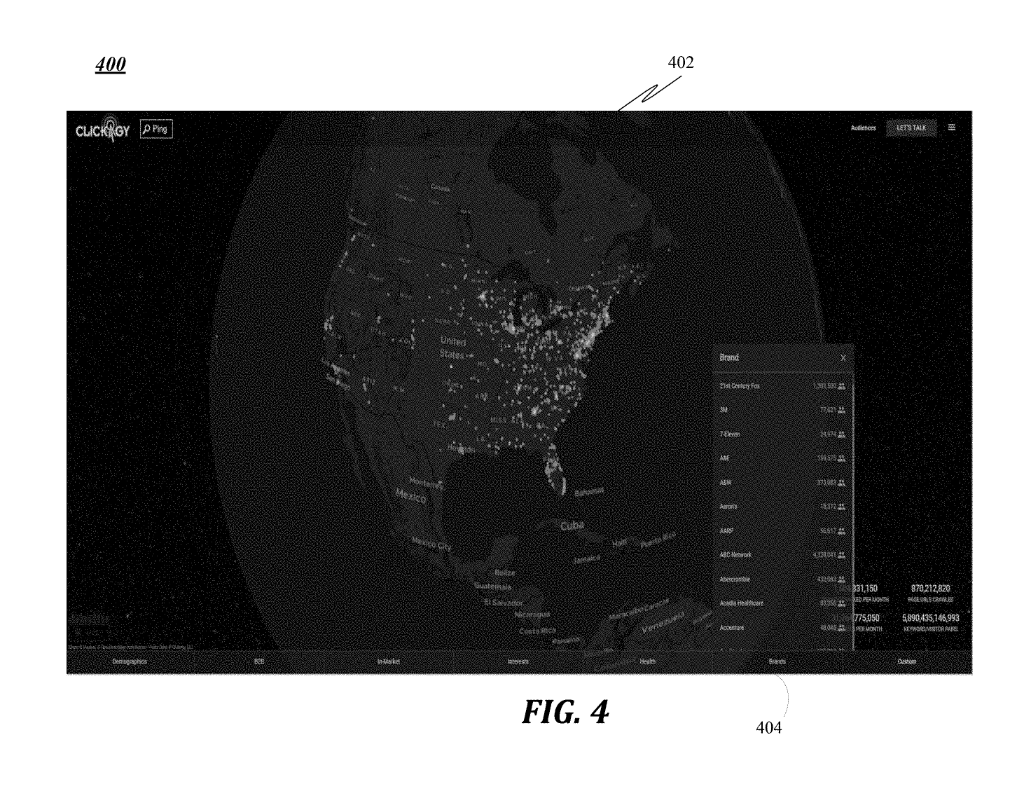

In another embodiment, when a user engages the platform 100, a code, such as Javascript code, embedded in the webpage may execute a method 1200 such that the online platform for providing map based visualizations of user interaction data presents an illustrative display screen representing the behavior data as illustrated in FIG. 4. Accordingly, data presentation screen 400, displays an embodiment of a Brands view. Additionally, callout 402, shows a graphical map display in accordance with the present disclosure. Furthermore, callout 404, indicates a representation of the Brands menu in accordance with the present disclosure.

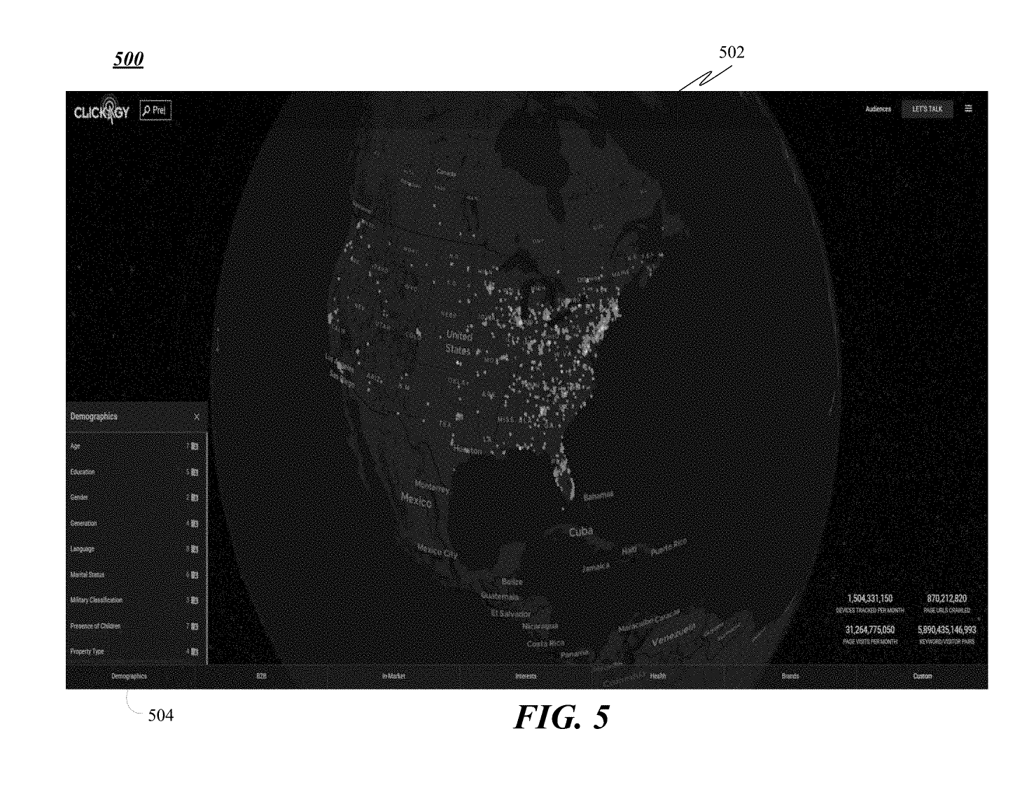

In another embodiment, when a user engages the platform 100, a code, such as Javascript code, embedded in the webpage may execute a method 1200 such that the online platform for providing map based visualizations of user interaction data presents an illustrative display screen representing the behavior data as illustrated in FIG. 5. Accordingly, data presentation screen 500, displays an embodiment of a demographics view. Additionally, callout 502, shows a graphical map display in accordance with the present disclosure. Furthermore, callout 504, indicates a representation of the demographics menu in accordance with the present disclosure.

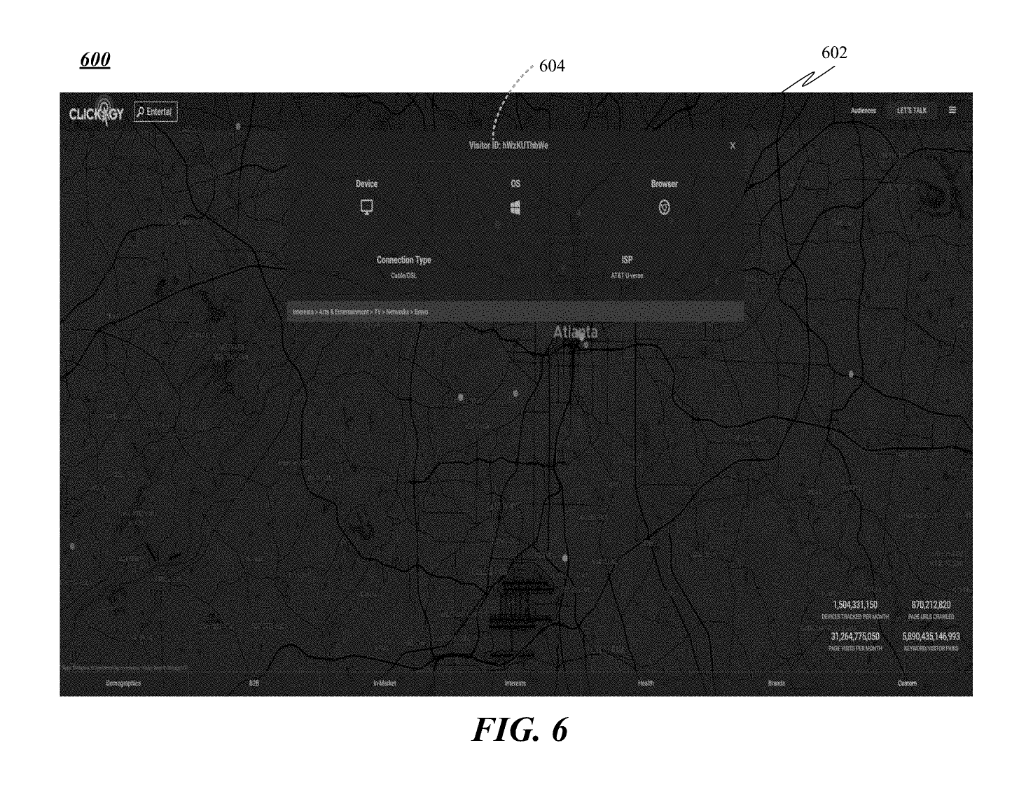

In another embodiment, when a user engages the platform 100, a code, such as Javascript code, embedded in the webpage may execute a method 1200 such that the online platform for providing map based visualizations of user interaction data presents an illustrative display screen representing the behavior data as illustrated in FIG. 6.

Accordingly, data presentation screen 600, displays an embodiment of a view of a data point example. Additionally, callout 602, shows a graphical map display in accordance with the present disclosure. Furthermore, callout 604, indicates a representation of a selected data point in accordance with the present disclosure.

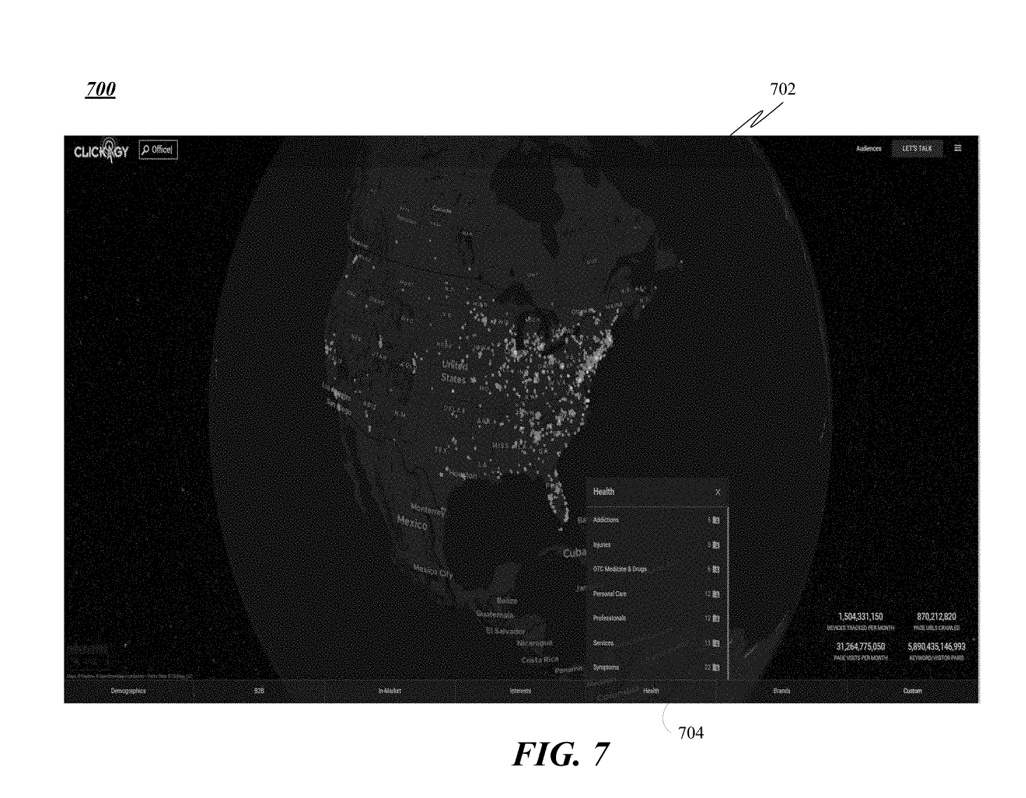

In another embodiment, when a user engages the platform 100, a code, such as Javascript code, embedded in the webpage may execute a method 1200 such that the online platform for providing map based visualizations of user interaction data presents an illustrative display screen representing the behavior data as illustrated in FIG. 7. Accordingly, data presentation screen 700, displays an embodiment of a health view. Additionally, callout 702, shows a graphical map display in accordance with the present disclosure. Furthermore, callout 704, indicates a representation of the health menu in accordance with the present disclosure.

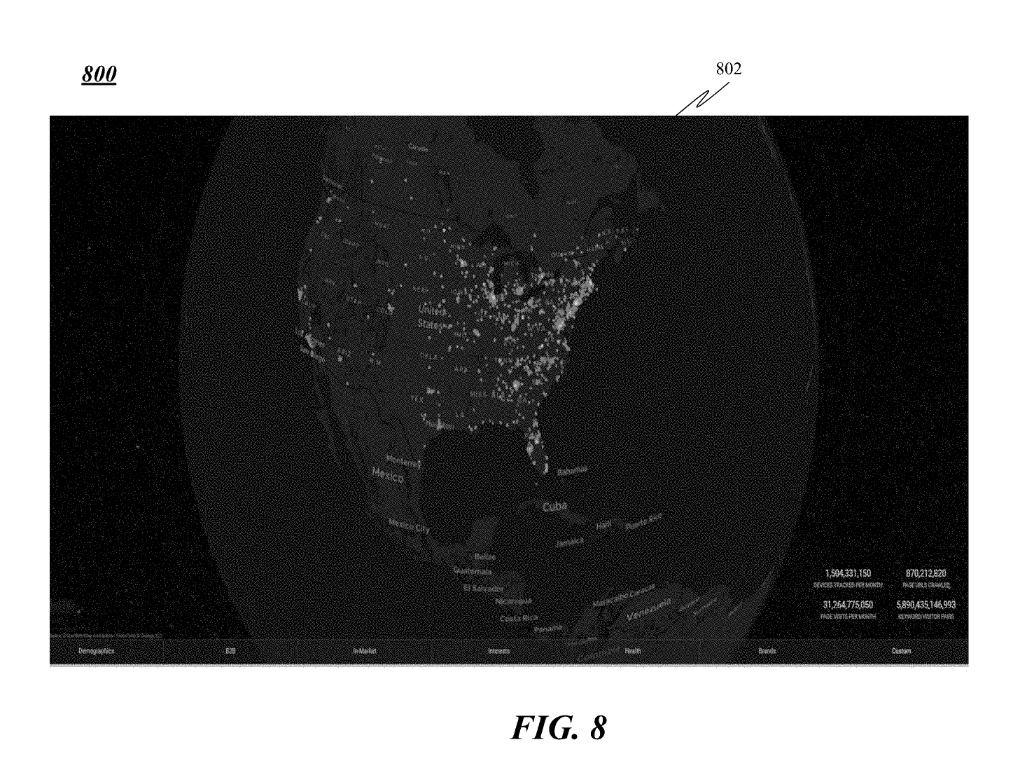

In another embodiment, when a user engages the platform 100, a code, such as Javascript code, embedded in the webpage may execute a method 1200 such that the online platform for providing map based visualizations of user interaction data presents an illustrative display screen representing the behavior data as illustrated in FIG. 8. Accordingly, data presentation screen 800, displays an embodiment of a home screen view. Additionally, callout 802, shows a graphical map display in accordance with the present disclosure.

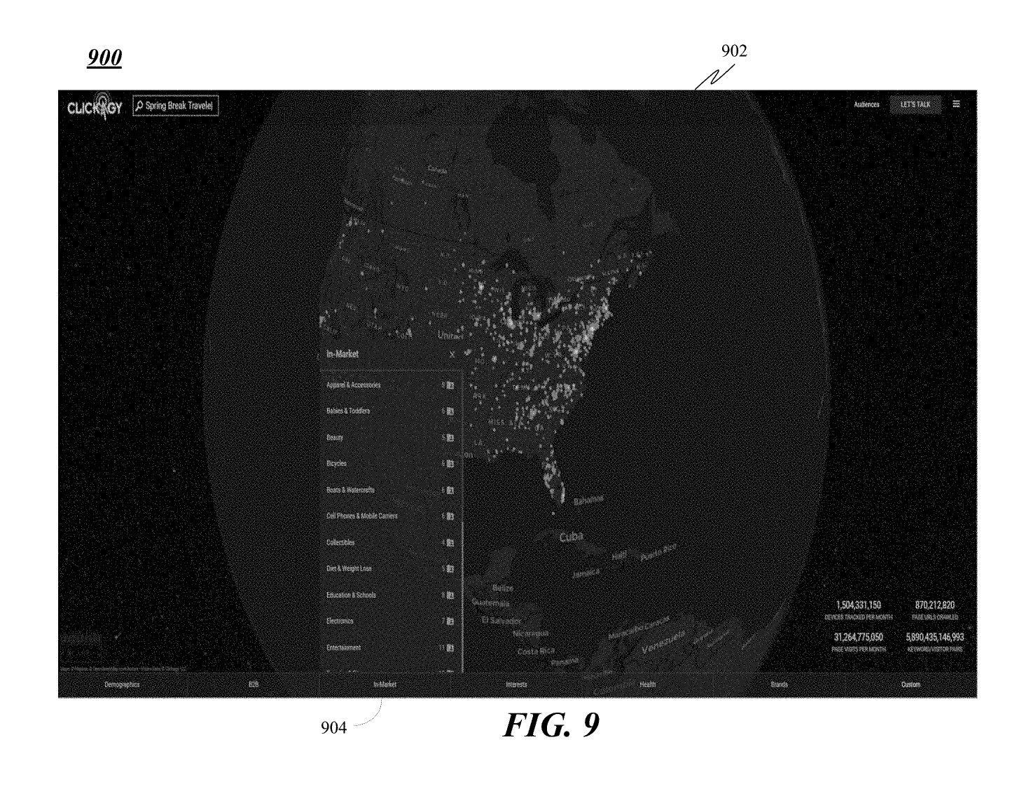

In another embodiment, when a user engages the platform 100, a code, such as Javascript code, embedded in the webpage may execute a method 1200 such that the online platform for providing map based visualizations of user interaction data presents an illustrative display screen representing the behavior data as illustrated in FIG. 9. Accordingly, data presentation screen 900, displays an embodiment of a In-Market view. Additionally, callout 902, shows a graphical map display in accordance with the present disclosure. Furthermore, callout 904, indicates a representation of the In-Market menu in accordance with the present disclosure.

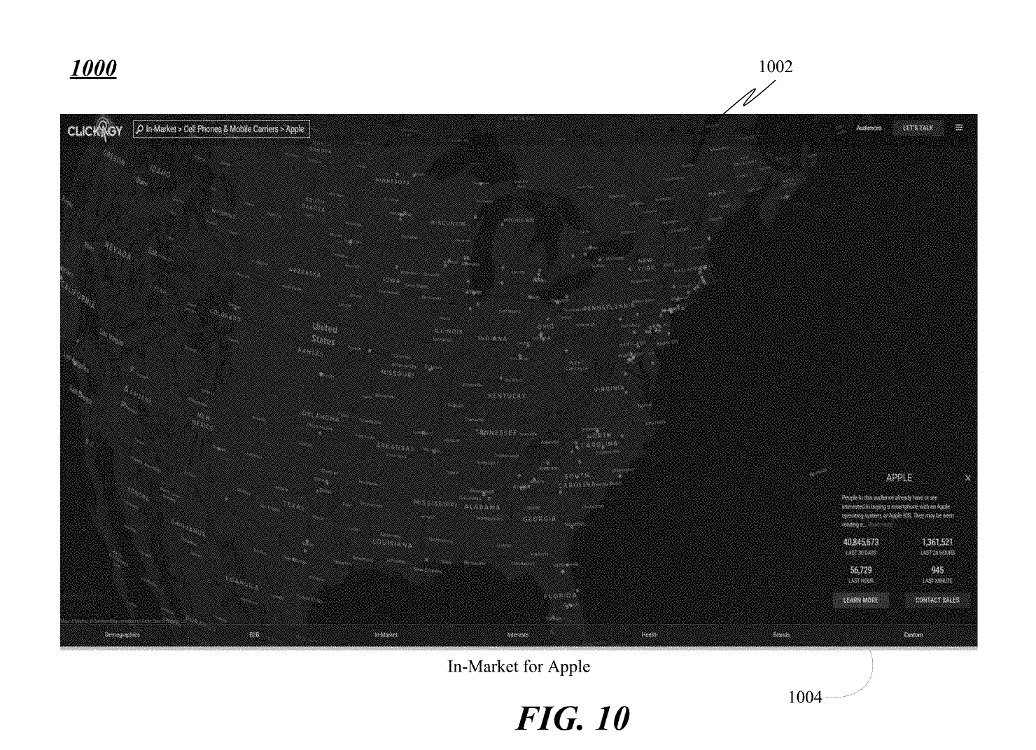

In another embodiment, when a user engages the platform 100, a code, such as Javascript code, embedded in the webpage may execute a method 1200 such that the online platform for providing map based visualizations of user interaction data presents an illustrative display screen representing the behavior data as illustrated in FIG. 10. Accordingly, data presentation screen 1000, displays an embodiment of an In-Market view of Apple™ devices and/or activity in accordance with the present disclosure. Additionally, callout 1002, shows a graphical map display in accordance with the present disclosure.

Furthermore, callout 1004, indicates a representation of the In-Market popup display in accordance with the present disclosure.

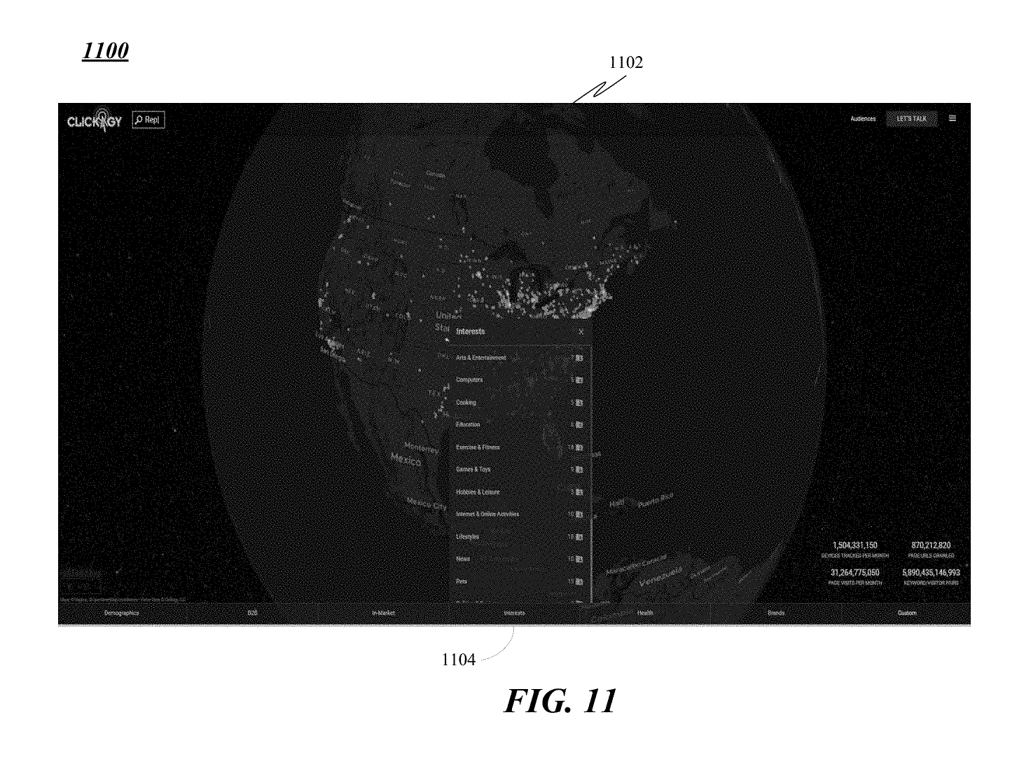

In another embodiment, when a user engages the platform 100, a code, such as Javascript code, embedded in the webpage may execute a method 1200 such that the online platform for providing map based visualizations of user interaction data presents an illustrative display screen representing the behavior data as illustrated in FIG. 11. Accordingly, data presentation screen 1100, displays an embodiment of an Interests view. Additionally, callout 1102, shows a graphical map display in accordance with the present disclosure. Furthermore, callout 1104, indicates a representation of the Interests menu in accordance with the present disclosure.

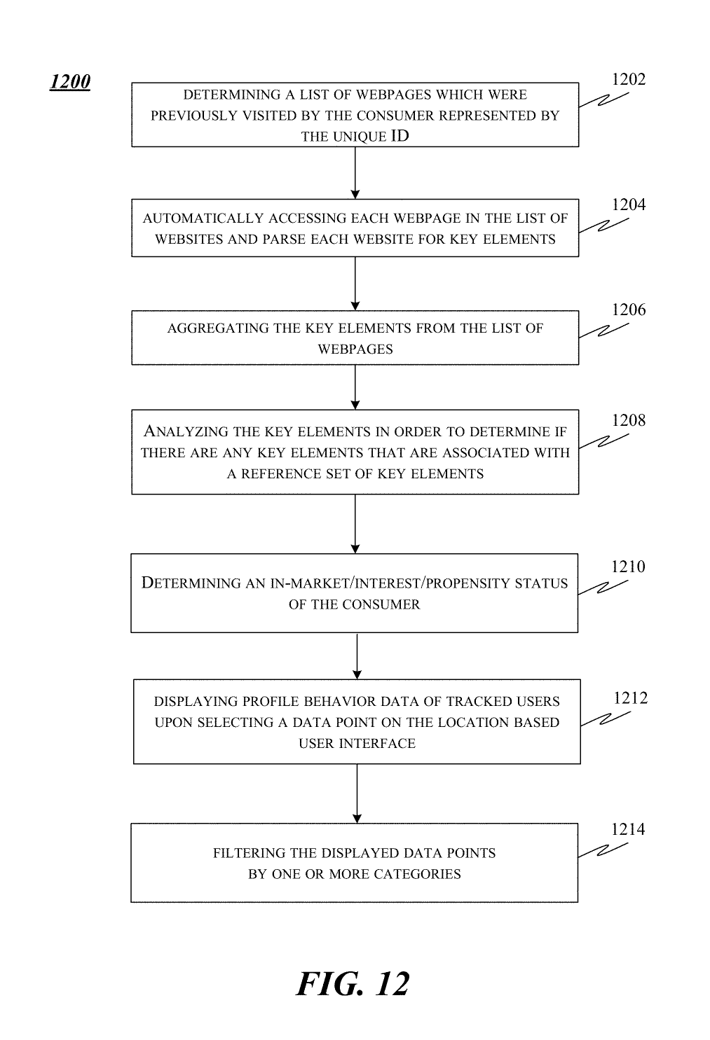

According to some embodiments, when the consumer visits a webpage using the consumer device, the webpage may be able to identify the unique ID associated with the consumer based on information associated with the consumer device and subsequently execute a method 1200 as illustrated in FIG. 12.

In various other anticipated embodiments, method 1200 would not require the execution of method 200 as a triggering event. For example, in some embodiments, the unique IDs may be determined based on, for example, cross-referencing at least one dataset belonging to a platform user to at least one dataset available to the platform (e.g., using email-hash cross-referencing techniques). As such, during an on-boarding or setup phase, a platform user may provide at least one of the following: 1) a list of targeted lead data (which may include, but not be limited to, at least one non-personally indefinable data point for the leads); and 2) areas of targeted lead interest (which may include, but not be limited to, for example keywords). In other embodiments, lead data may not be provided. Instead, as another example, a platform user may provide a desired threshold ‘confidence level’ associated with the areas of targeted lead interest. In turn, the platform may be enabled to assess the universe of unique IDs to determine which of those unique IDs may be associated with a threshold confidence level for key elements corresponding to the area of targeted lead interest.

Consistent with embodiments, method 1200 may begin at stage 1202, which may include identifying and logging a list of webpages which were previously visited by the consumer represented by a unique ID of interest. Moreover, the platform may be enabled to maintain or access an up-to-date list all webpages visit by the identified consumer after a triggering event.

Determining the unique ID of interest may be established by, for example, but not limited to, method 200. In some embodiments, a platform user may upload a list of unique IDs for tracking purposes. In other embodiments, the unique IDs may be determined based on, for example, cross-referencing at least one dataset belonging to a platform user to at least one dataset available to the platform (e.g., using email-hash, social handle, address, phone number, and other non-PII and/or PII cross-referencing techniques).

The method 1200 may include a stage 1204 of automatically accessing each webpage in the list of webpages and parse each webpage for key elements. Key elements, as used herein, may include, but not be limited to, webpage structure, text, images, video, audio, and combinations thereof. In some embodiments, the webpage may have been previously processed in accordance to this stage.

Additionally, the method 1200 may include a stage 1206 of aggregating the key elements from the list of webpages. In some embodiments, the webpage may have been previously processed in accordance to this stage.

Further, the method 1200 may include a stage 1208 of analyzing the key elements. As one example of an analysis stage, the platform may be configured to assign scores to key elements in order to determine if there are any key elements that are associated with a set of reference key elements (e.g., established during a setup or onboarding phase). As such, the scores may be assigned based on a comparison between the key elements and the reference key elements obtained during the setup phase. Furthermore, the method may include identifying one or more patterns in the key elements. The one or more patterns may be identified based on the raw data comprising the key elements, machine learning, AI processing of the key elements and so on. It should be understood that the method of ‘scoring’ is only one of many possible techniques to perform an analysis consistent with the present disclosure.

Additionally, in some instances, the method 1200 may further include a stage of adding a weight to more recent key elements. In other words, the method may incorporate a time factor. Accordingly, for instance, if more than 3 webpages with recent key elements are identified, such key elements are identified as ‘younger key elements’ and accordingly given a higher weight in determining whether the consumer is in-market. It should be understood that the method of ‘weighting’ is only one of many possible techniques to perform an analysis consistent with the present disclosure.

For example, if the consumer visited three webpages containing content on Nike running shoes within a predetermined period of time (e.g, may be established during a setup or onboarding phase), then they are determined to be in-market for Nike running shoes.

Upon analysis, the method 1200 may further include a stage 1210 determining the in-market (e.g., interest/propensity) status of the consumer in one or more of the consumer device. For example, a data field associated with the Unique ID may be set to ‘true,’ ‘in-market,’ or ‘interested’.

Upon analysis, the method 1200 may further include a stage 1212 displaying profile behavior data of tracked users upon selecting a data point on the location based user interface. For example, displaying profile (i.e. behavior data) of tracked users upon selecting a data-point on the location based user interface.

Upon analysis, the method 1200 may further include a stage 1214 filtering the displayed data points by one or more categories. For example, filtering the displayed data points by one or more categories wherein the categories at least include “In-Market” and “Interests”.

Further, according to some embodiments, the method may include cross referencing the consumer with a Customer Relationship Management (CRM) database associated with a platform user. For example, data associated with the consumer, such as, but not limited to, the in-market status of the consumer in relation to one or more products and/or services along with respective confidence values, key elements, the list of webpages visited etc. may be stored in a record associated with the consumer in the CRM database. The data may further include propensity and interest-level data for each cross referenced consumer in the CRM database. (See the '178 disclosure.) This may be done based on, for example, a common reference point. For example, the login provided by the consumer may be associated with an email address of the consumer as stored in the CRM database through a network cookie. Other common reference points may be used, such as, for example, but not limited to email-hash, social handle, address, phone number, and other non-PII and/or PII cross-reference elements.

Additionally, in some embodiments, the method may include triggering a marketing campaign based on the in-market status of the consumer. For example, the marketing campaign may include be carried out on one or more channels such as, email, SMS, social media messaging, telephonic calls, video calls, in-person meetings etc.

The aforementioned stages may be repeated for dynamically updated lists of webpages the consumer has been determined to have visited. In such update, the data field may be modified based on the new data. Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of methods 200 and 1200 will be described in greater detail below.

### IV. Computing Device Architecture

Platform 100 may be embodied as, for example, but not be limited to, a website, a web application, a desktop application, backend application, and a mobile application compatible with a computing device 1300. The computing device 1300 may comprise, but not be limited to the following:
Mobile computing device such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series; and
A microcomputer, wherein the microcomputer computing device comprises, but is not limited to, a server, wherein a server may be rack mounted, a workstation, an industrial device, a raspberry pi, a desktop, or an embedded device.

Platform 001 may be hosted on a centralized server or a cloud computing service. Although methods have been described to be performed by a computing device 1300, it should be understood that, in some embodiments, different operations may be performed by a plurality of the computing devices 1300 in operative communication over one or more networks.

Embodiments of the present disclosure may comprise a system having a central processing unit (CPU) 1320, a bus 1330, a memory unit 1340, a power supply unit (PSU) 1350, and one or more Input/Output (I/O) units. The CPU 1320 coupled to the memory unit 1340 and the plurality of I/O units 1360 via the bus 1330, all of which are powered by the PSU 1350. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 13 is a block diagram of a system including computing device 1300. Consistent with an embodiment of the disclosure, the aforementioned CPU 1320, the bus 1330, the memory unit 1340, a PSU 1350, and the plurality of I/O units 1360 may be implemented in a computing device, such as computing device 1300 of FIG. 13. Any suitable combination of hardware, software, or firmware may be used to implement the aforementioned units. For example, the CPU 1320, the bus 1330, and the memory unit 1340 may be implemented with computing device 1300 or any of other computing devices 1300, in combination with computing device 1300. The aforementioned system, device, and components are examples and other systems, devices, and components may comprise the aforementioned CPU 1320, the bus 1330, the memory unit 1340, consistent with embodiments of the disclosure.

One or more computing devices 1300 may be embodied as any of the computing elements illustrated in FIG. 1A and 1B, including, but not limited to, Capturing Devices 025, Data Store 020, Interface Layer 015 such as User and Admin interfaces, Recognition Module 065, Content Module 055, Analysis Module 075 and neural net. A computing device 1300 does not need to be electronic, nor even have a CPU 1320, nor bus 1330, nor memory unit 1340. The definition of the computing device 1300 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 1300, especially if the processing is purposeful.

With reference to FIG. 13, a system consistent with an embodiment of the disclosure may include a computing device, such as computing device 900. In a basic configuration, computing device 900 may include at least one clock module 910, at least one CPU 920, at least one bus 930, and at least one memory unit 940, at least one PSU 950, and at least one I/O 960 module, wherein I/O module may be comprised of, but not limited to a non-volatile storage sub-module 1361, a communication sub-module 1362, a sensors sub-module 1363, and a peripherals sub-module 1364.

A system consistent with an embodiment of the disclosure the computing device 1300 may include the clock module 1310 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 1320, the central component of modern computers, which relies on a clock. The only exceptions are asynchronous circuits such as asynchronous CPUs. The clock 1310 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 1300 use a “clock multiplier” which multiplies a lower frequency external clock to the appropriate clock rate of the CPU 1320. This allows the CPU 1320 to operate at a much higher frequency than the rest of the computer, which affords performance gains in situations where the CPU 1320 does not need to wait on an external factor (like memory 1340 or input/output 1360). Some embodiments of the clock 1310 may include dynamic frequency change, where, the time between clock edges can vary widely from one edge to the next and back again.

A system consistent with an embodiment of the disclosure the computing device 1300 may include the CPU unit 1320 comprising at least one CPU Core 1321. A plurality of CPU cores 1321 may comprise identical the CPU cores 1321, such as, but not limited to, homogeneous multi-core systems. It is also possible for the plurality of CPU cores 1321 to comprise different the CPU cores 1321, such as, but not limited to, heterogeneous multi-core systems, big.LITTLE systems and some AMD accelerated processing units (APU). The CPU unit 1320 reads and executes program instructions which may be used across many application domains, for example, but not limited to, general purpose computing, embedded computing, network computing, digital signal processing (DSP), and graphics processing (GPU). The CPU unit 1320 may run multiple instructions on separate CPU cores 1321 at the same time. The CPU unit 1320 may be integrated into at least one of a single integrated circuit die and multiple dies in a single chip package. The single integrated circuit die and multiple dies in a single chip package may contain a plurality of other aspects of the computing device 1300, for example, but not limited to, the clock 1310, the CPU 1320, the bus 1330, the memory 1340, and I/O 1360.

The CPU unit 1321 may contain cache 1322 such as, but not limited to, a level 1 cache, level 2 cache, level 3 cache or combination thereof. The aforementioned cache 1322 may or may not be shared amongst a plurality of CPU cores 1321. The cache 1322 sharing comprises at least one of message passing and inter-core communication methods may be used for the at least one CPU Core 1321 to communicate with the cache 1322. The inter-core communication methods may comprise, but not limited to, bus, ring, two-dimensional mesh, and crossbar. The aforementioned CPU unit 1320 may employ symmetric multiprocessing (SMP) design.

The plurality of the aforementioned CPU cores 1321 may comprise soft microprocessor cores on a single field programmable gate array (FPGA), such as semiconductor intellectual property cores (IP Core). The plurality of CPU cores 1321 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 1321, for example, but not limited to Instruction-level parallelism (ILP) such as, but not limited to, superscalar pipelining, and Thread-level parallelism (TLP).

Consistent with the embodiments of the present disclosure, the aforementioned computing device 1300 may employ a communication system that transfers data between components inside the aforementioned computing device 1300, and/or the plurality of computing devices 1300. The aforementioned communication system will be known to a person having ordinary skill in the art as a bus 1330. The bus 1330 may embody internal and/or external plurality of hardware and software components, for example, but not limited to a wire, optical fiber, communication protocols, and any physical arrangement that provides the same logical function as a parallel electrical bus. The bus 1330 may comprise at least one of, but not limited to a parallel bus, wherein the parallel bus carry data words in parallel on multiple wires, and a serial bus, wherein the serial bus carry data in bit-serial form. The bus 1330 may embody a plurality of topologies, for example, but not limited to, a multidrop/electrical parallel topology, a daisy chain topology, and a connected by switched hubs, such as USB bus. The bus 1330 may comprise a plurality of embodiments, for example, but not limited to
Internal data bus (data bus) 1331/Memory bus
Control bus 1332
Address bus 1333
System Management Bus (SMBus)
Front-Side-Bus (FSB)
External Bus Interface (EBI)
Local bus
Expansion bus
Lightning bus
Controller Area Network (CAN bus)
Camera Link
xpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (i.g. PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA) including embodiments such as, but not limited to Extended ISA (EISA), PC/XT-bus/PC/AT-bus/PC/104 bus (e.g. PC/104-Plus, PCl/104-Express, PCl/104, and PCI-104), and Low Pin Count (LPC).
Music Instrument Digital Interface (MIDI)
Universal Serial Bus (USB) including embodiments such as, but not limited to, Media Transfer Protocol (MTP)/Mobile High-Definition Link (MHL), Device Firmware Upgrade (DFU), wireless USB, InterChip USB, IEEE 13134 Interface/Firewire, Thunderbolt, and eXtensible Host Controller Interface (xHCI).

Consistent with the embodiments of the present disclosure, the aforementioned computing device 1300 may employ hardware integrated circuits that store information for immediate use in the computing device 1300, know to the person having ordinary skill in the art as primary storage or memory 1340. The memory 1340 operates at high speed, distinguishing it from the non-volatile storage sub-module 1361, which may be referred to as secondary or tertiary storage, which provides slow-to-access information but offers higher capacities at lower cost. The contents contained in memory 1340, may be transferred to secondary storage via techniques such as, but not limited to, virtual memory and swap. The memory 1340 may be associated with addressable semiconductor memory, such as integrated circuits consisting of silicon-based transistors, used for example as primary storage but also other purposes in the computing device 1300. The memory 1340 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 1341, Static Random-Access Memory (SRAM) 1342, CPU Cache memory 1325, Advanced Random-Access Memory (A-RAM), and other types of primary storage such as Random-Access Memory (RAM).
Non-volatile memory which can retain stored information even after power is removed, for example, but not limited to, Read-Only Memory (ROM) 1343, Programmable ROM (PROM) 1344, Erasable PROM (EPROM) 1345, Electrically Erasable PROM (EEPROM) 1346 (e.g. flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 1300 may employ the communication system between an information processing system, such as the computing device 1300, and the outside world, for example, but not limited to, human, environment, and another computing device 1300. The aforementioned communication system will be known to a person having ordinary skill in the art as I/O 1360. The I/O module 1360 regulates a plurality of inputs and outputs with regard to the computing device 1300, wherein the inputs are a plurality of signals and data received by the computing device 1300, and the outputs are the plurality of signals and data sent from the computing device 1300. The I/O module 1360 interfaces a plurality of hardware, such as, but not limited to, non-volatile storage 1361, communication devices 1362, sensors 1363, and peripherals 1364. The plurality of hardware is used by the at least one of, but not limited to, human, environment, and another computing device 1300 to communicate with the present computing device 1300. The I/O module 1360 may comprise a plurality of forms, for example, but not limited to channel I/O, port-mapped I/O, asynchronous I/O, and Direct Memory Access (DMA).

Consistent with the embodiments of the present disclosure, the aforementioned computing device 1300 may employ the non-volatile storage sub-module 1361, which may be referred to by a person having ordinary skill in the art as one of secondary storage, external memory, tertiary storage, off-line storage, and auxiliary storage. The non-volatile storage sub-module 1361 may not be accessed directly by the CPU 1320 without using intermediate area in the memory 1340. The non-volatile storage sub-module 1361 does not lose data when power is removed and may be two orders of magnitude less costly than storage used in memory module, at the expense of speed and latency. The non-volatile storage sub-module 1361 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (1361) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO)
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, and Solid State Drive (SSD) and memristor
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD)
Molecular Memory
Deoxyribonucleic Acid (DNA) digital data storage

Consistent with the embodiments of the present disclosure, the aforementioned computing device 1300 may employ the communication sub-module 1362 as a subset of the I/O 1360, which may be referred to by a person having ordinary skill in the art as at least one of, but not limited to, computer network, data network, and network. The network allows computing devices 1300 to exchange data using connections, which may be known to a person having ordinary skill in the art as data links, between network nodes. The nodes comprise network computer devices 1300 that originate, route, and terminate data. The nodes are identified by network addresses and can include a plurality of hosts consistent with the embodiments of a computing device 1300. The aforementioned embodiments include, but not limited to personal computers, phones, servers, drones, and networking devices such as, but not limited to, hubs, switches, routers, modems, and firewalls.

Two nodes can be said are networked together, when one computing device 1300 is able to exchange information with the other computing device 1300, whether or not they have a direct connection with each other. The communication sub-module 1362 supports a plurality of applications and services, such as, but not limited to World Wide Web (WWW), digital video and audio, shared use of application and storage computing devices (1300), printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g. TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g. Global System for Mobile Communications [GSM], General Packet Radio Service [GPRS], Code-Division Multiple Access [CDMA], and Integrated Digital Enhanced Network [IDEN]).

The communication sub-module 1362 may comprise a plurality of size, topology, traffic control mechanism and organizational intent. The communication sub-module 1362 may comprise a plurality of embodiments, such as, but not limited to
Wired such as, but not limited to, coaxial cable, phone lines, twisted pair cables (ethernet), and InfiniBand.
Wireless communications such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G
Parallel communications such as, but not limited to, LPT ports.
Serial communications such as, but not limited to, RS-232 and USB
Fiber Optic communications such as, but not limited to, Single-mode optical fiber (SMF) and Multi-mode optical fiber (MMF)
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 1300 may employ the sensors sub-module 1363 as a subset of the I/O 1360. The sensors sub-module 1363 comprises at least one of the devices, modules, and subsystems whose purpose is to detect events or changes in its environment and send the information to the computing device 1300. Sensors are sensitive to the measured property, are not sensitive to any property not measured, but may be encountered in its application, and do not significantly influence the measured property. The sensors sub-module 1363 may comprise a plurality of digital devices and analog devices, wherein if an analog device is used, an Analog to Digital (A-to-D) converter must be employed to interface the said device with the computing device 1300. The sensors may be subject to a plurality of deviations that limit sensor accuracy. The sensors sub-module 1363 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors such as, but not limited to, microphone, lace sensor (guitar pickup), seismometer, sound locator, geophone, and hydrophone.
Electric current, electric potential, magnetic, and radio sensors such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors such as, but not limited to, air flow meter, anemometer, flow sensor, gas meter, mass flow sensor, and water meter.
Ionizing radiation and particle sensors such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors such as, but not limited to, accelerometer, displacement sensor, flex sensor, free fall sensor, gravimeter, impact sensor, laser rangefinder, LIDAR, odometer, photoelectric sensor, position sensor such as GPS or Glonass, angular rate sensor, shock detector, ultrasonic sensor, tilt sensor, tachometer, ultra-wideband radar, variable reluctance sensor, and velocity receiver.
Imaging, optical and light sensors such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors such as, but not limited to, bhangmeter, hydrometer, force gauge/force sensor, level sensor, load cell, magnetic level/nuclear density/strain gauge, piezocapacitive pressure sensor, piezoelectric sensor, torque sensor, and viscometer.
Thermal and temperature sensors such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 1300 may employ the peripherals sub-module 1362 as a subset of the I/O 1360. The peripheral sub-module 1364 comprises ancillary devices uses to put information into and get information out of the computing device 1300. There are 3 categories of devices comprising the peripheral sub-module 1364, which exist based on their relationship with the computing device 1300, input devices, output devices, and input/output devices. Input devices send at least one of data and instructions to the computing device 1300. Input devices can be categorized based on, but not limited to:
Modality of input such as, but not limited to, mechanical motion, audio, and visual
Whether the input is discrete, such as but not limited to, pressing a key, or continuous such as, but not limited to position of a mouse
The number of degrees of freedom involved such as, but not limited to, two-dimensional mice vs three-dimensional mice used for Computer-Aided Design (CAD) applications

Output devices provide output from the computing device 1300. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 1364:
Input Devices
   Human Interface Devices (HID), such as, but not limited to, pointing device (e.g. mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 1300. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 1300 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices covert at least one of analog signals and physical parameters to digital values for processing by the computing device 1300. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, and Refreshable Braille Display/Braille Terminal.
   Printers such as, but not limited to, inkjet printers, laser printers, 3D printers, and plotters.
   Audio and Video (AV) devices such as, but not limited to, speakers, headphones, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g. devices disclosed in network 1362 sub-module), data storage device (non-volatile storage 1361), facsimile (FAX), and graphics/sound cards.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A computer implemented method comprising:
gathering online behavior of a consumer device operated by a consumer across a plurality of webpages;
analyzing the online behavior;
determining an in-market status of the consumer, the in-market status corresponding to at least one of the following: a product and a service associated with a platform user;
displaying, to the platform user, online behavior of the consumer associated with a location, the location being graphically displayed as one or more data points on a map;
filtering the displayed online behavior of the consumer by one or more categories, the one or more categories being associated with the in-market status; and
exporting, to the platform user, the filtered displayed online behavior data as a list of consumers associated with the one or more categories.

2. The computer implemented method of claim 1, further comprising updating the displayed online behavior of the consumer associated with the location based on the filtering step.

3. The computer implemented method of claim 1, wherein the one or more categories includes at least one of: In-Market, Interests, Demographics, B2B, Brands, health, home, In-Market Brands.

4. The computer implemented method of claim 1, wherein the gathering comprises extracting at least one key element from a webpage visited by the consumer.

5. The computer implemented method of claim 1, wherein the gathering comprises extracting content from the plurality of webpages, wherein the analyzing comprises performing machine learning over content.

6. The computer implemented method of claim 5, wherein the machine learning is at least one of a supervised machine learning and an unsupervised machine learning.

7. The computer implemented method of claim 1, wherein the online behavior comprises at least one of visiting the plurality of webpages, interacting with the plurality of webpages, downloading the plurality of webpages, purchasing at least one of a product and a service associated with the plurality of webpages.

8. The computer implemented method of claim 1, wherein the online behavior comprises performing a payment at a Point of Sale (POS) terminal, wherein the payment is towards at least one of a product and a service associated with the plurality of webpages.

9. The computer implemented method of claim 1, further comprising storing a tracking cookie on a consumer device operated by the consumer, wherein the gathering is performed, at least in part, by employing the tracking cookie.

10. The computer implemented method of claim 1, further comprising receiving indication of at least one of the product and the service from a platform user.

11. The computer implemented method of claim 10, wherein receiving the indication comprises analyzing a parameter associated with the platform user.

12. The computer implemented method of claim 1, further comprising:
parsing content of at least one webpage operated by the platform user; and
identifying at least one of the product and the service based on the parsing.

13. The computer implemented method of claim 12, further comprising extracting a reference set of key elements associated with at least one of the product and the service based on the parsing.

14. The computer implemented method of claim 13, wherein filtering the displayed online behavior is based on the reference set of key elements.

15. The computer implemented method of claim 13, further comprising:
receiving a request to access a webpage of the plurality of webpages by the consumer device operated by the consumer;
identifying the consumer based on at least one unique identifier associated with the request;
identifying at least one other webpage of the plurality of webpages visited by the consumer based on the at least one unique identifier; and
extracting a comparison set of key elements from the at least one other webpage, wherein the analyzing comprises analyzing the comparison set of key elements, wherein determining the in-market status of the consumer for at least one of the product and the service offered by the webpage is based on analyzing of the comparison set of key elements to the reference set of key elements.

16. The computer implemented method of claim 15, wherein analyzing the set of key elements comprises comparing the set of key elements with the reference set of key elements associated with the webpage, wherein the reference set of key elements represents at least one of the product and the service offered by the webpage.

17. The computer implemented method of claim 1, further comprising storing an in-market indicator on at least one of the consumer device and a server provisioning at least one webpage of the plurality of webpages.

18. The computer implemented method of claim 1, further comprising:
receiving a request to access a webpage by a consumer device operated by the consumer;
identifying the consumer based on at least one unique identifier associated with the request;
retrieving the in-market status associated with the consumer; and
transmitting at least one advertisement to the consumer device based on the in-market status.

19. The computer implemented method of claim 1, further comprising updating a CRM database associated with at least one of the plurality of webpages with the in-market status of the consumer.

20. The computer implemented method of claim 19, wherein the exporting comprises exporting to the CRM database with in-market status indicators.
